(19) United States
(12) Patent Application Publication
(10) Pub. No.: US 2009/0236152 A1
(43) Pub. Date: Sep. 24, 2009

(54) SYSTEM AND METHOD FOR DATA ORGANIZATION BY IDENTIFICATION

(75) Inventors: Yih-Shiuan Liang, Emeryville, CA (US); Judah Menter, San Francisco, CA (US); Dao-Liang Chou, Berkleley, CA (US)

Correspondence Address: MURABITO, HAO & BARNES, LLP, TWO NORTH MARKET STREET, THIRD FLOOR, SAN JOSE, CA, 95113, US

(73) Assignee: LEAPFROG ENTERPRISES, INC., Emeryville, CA (US)

(21) Appl. No.: 12/053,496

(22) Filed: Mar. 21, 2008

(51) Int. Cl. G06K 11/06; G08C 21/00; G06F 3/041

(52) U.S. Cl. 178/19.01

(57) ABSTRACT

A system and method for data organization by identification. The system includes a bus, a processor coupled to the bus, a memory unit coupled to the bus, a writing element for allowing a user to create written items on a surface, and an optical detector coupled to the bus for detecting information on the surface. The system further includes software implemented on the processor which is responsive to a user selection of an identifier corresponding to a group of writing surfaces. The identifier is used to identify a data file corresponding to the group of writing surfaces. The software stores information based on writing on the group of writing surfaces.

### FIELD

The present invention is generally related to pen based computing systems.

### BACKGROUND

As computer technology has advanced, smaller more powerful devices such as handheld devices have been developed. One particular handheld device still undergoing substantial development and growth is pen based computing devices.

Some pen based computing devices allow information to be recorded as a user writes with the pen part of the device and to be uploaded to a computer. The pen based devices may keep track of the location by using dots on the writing surface called a dot space. Based on the location tracked by the device, the writing can be stored or recorded for upload to a computer.

Unfortunately, there is no way to organize data across copies of the same encoding or dot space. Using a copy of the same dot space will result in writing being added or written on top of the previous writings. For example, a notebook may have a dot space spread across its various pages and be used to by a student to take notes for a science class. When the student uses another notebook with the same dot space, the pen based device will be adding the writing over the current written data.

One solution is to create a new file corresponding to each writing surface. Unfortunately, since each writing surface corresponds to a separate file, the files are not associated with a group of writing surfaces. Thus, accessing and viewing all the files corresponding to a group of writing surfaces is cumbersome as the user must determine which files correspond to which writing surface.

Thus, what is needed is a way to reuse dot space without impacting previous data stored related to the dot space. Further what is needed is a way to allow appending written data to a file.

### SUMMARY

Embodiments of the present invention provide a solution for reusing encoding writing surfaces without impacting data stored related to previously used dot space.

In one embodiment, the present invention is implemented as an interactive device. The interactive device includes a bus, a processor coupled to the bus, a memory unit coupled to the bus, a writing element for allowing a user to create written items on a surface, and an optical detector coupled to the bus for detecting information on the surface. The system further includes software implemented on the processor which is responsive to a user selection of an identifier (e.g., a portion of an encoding different from the group of writing surfaces) corresponding to a group of writing surfaces (e.g., a notebook). The identifier is used to identify a data file corresponding to the group of writing surfaces (e.g., notebook). The software stores information based on writing on the group of writing surfaces.

In another embodiment, the present invention is implemented as an operating system of a computer system. The operating system can detect a unique identifier (e.g., portion of an encoding) corresponding to a writing surface (e.g., notebook). The identifier can be used to select a data file corresponding to the writing surface. The operating system can further store information based on actions (e.g., writing) performed in the data file corresponding to the writing surface.

In this manner, embodiments of the present invention facilitate appending and random access to data files corresponding to writing surfaces. Thus, an encoding (e.g., dot space) can be reused on a plurality of writing surfaces (e.g., separate notebooks).

In another embodiment, the present invention is implemented as a method for facilitating data organization. The method includes detecting an identifier (e.g., a portion of dot space) corresponding to a writing surface (e.g., notebook) and selecting a file corresponding to the writing surface. The method further includes receiving input via an optical detector when a writing element contacts the writing surface and storing the input in the file corresponding to the writing surface. The method can include creating a new file corresponding to the writing surface. The method also facilitates appending and random access to the file corresponding to the writing surface.

### BRIEF DESCRIPTION OF THE DRAWINGS

The present invention is illustrated by way of example, and not by way of limitation, in the figures of the accompanying drawings and in which like reference numerals refer to similar elements.

FIG. 1 is a block diagram of a device upon which embodiments of the present invention can be implemented.

FIG. 2 is a block diagram of another device upon which embodiments of the present invention can be implemented.

FIG. 3 shows an exemplary sheet of paper provided with a pattern of marks according to one embodiment of the present invention.

FIG. 4 shows an enlargement of a pattern of marks on an exemplary sheet of paper according to one embodiment of the present invention.

FIG. 5 shows an exemplary identifier selection in accordance with one embodiment of the present invention.

FIG. 6 shows an exemplary notebook in accordance with one embodiment of the present invention.

FIG. 7 shows a flowchart of a process for detecting a connection in accordance with one embodiment of the present invention.

### DETAILED DESCRIPTION

Reference will now be made in detail to the embodiments of the present invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

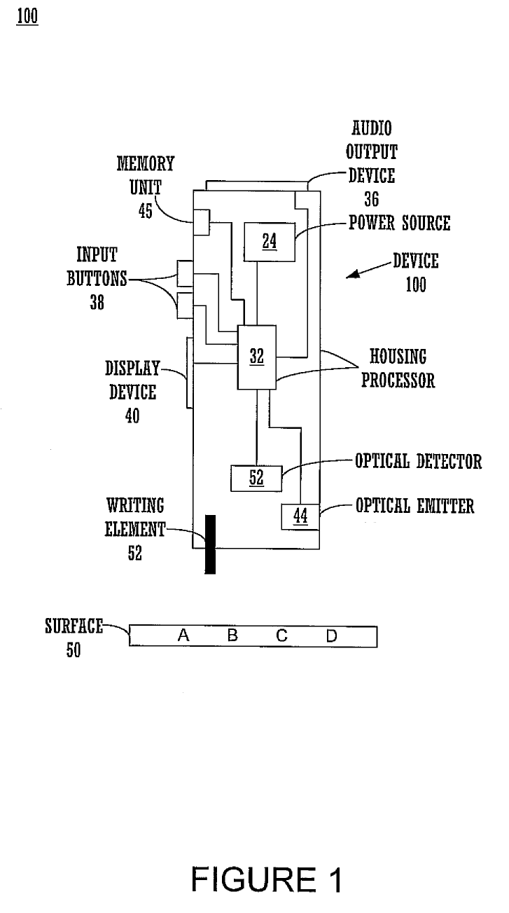

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., pen device 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### EMBODIMENTS OF THE INVENTION

FIG. 1 is a block diagram of a pen device 100 upon which embodiments of the present invention can be implemented. In general, pen device 100 may be referred to as an optical device, more specifically as an optical reader, optical pen or digital pen. The device may contain a computer system and an operating system resident thereon. Application programs may also reside thereon.

In the embodiment of FIG. 1, pen device 100 includes a processor 32 inside a housing 62. In one embodiment, housing 62 has the form of a pen or other writing or marking utensil or instrument. Processor 32 is operable for processing information and instructions used to implement the functions of pen device 100, which are described below.

In the present embodiment, the pen device 100 may include an audio output device 36 and a display device 40 coupled to the processor 32. In other embodiments, the audio output device and/or the display device are physically separated from pen device 100, but in communication with pen device 100 through either a wired or wireless connection. For wireless communication, pen device 100 can include a transceiver or transmitter (not shown in FIG. 1). The audio output device 36 may include a speaker or an audio jack (e.g., for an earphone or headphone). The display device 40 may be a liquid crystal display (LCD) or some other suitable type of display.

In the embodiment of FIG. 1, pen device 100 may include input buttons 38 coupled to the processor 32 for activating and controlling the pen device 100. For example, the input buttons 38 allow a user to input information and commands to pen device 100 or to turn pen device 100 on or off. Pen device 100 also includes a power source 34 such as a battery.

Pen device 100 also includes a light source or optical emitter 44 and a light sensor or optical detector 42 coupled to the processor 32. The optical emitter 44 may be a light emitting diode (LED), for example, and the optical detector 42 may be a charge coupled device (CCD) or complementary metal-oxide semiconductor (CMOS) imager array, for example. The optical emitter 44 illuminates surface 70 or a portion thereof. Light reflected from the surface 70 is received at and recorded by optical detector 42.

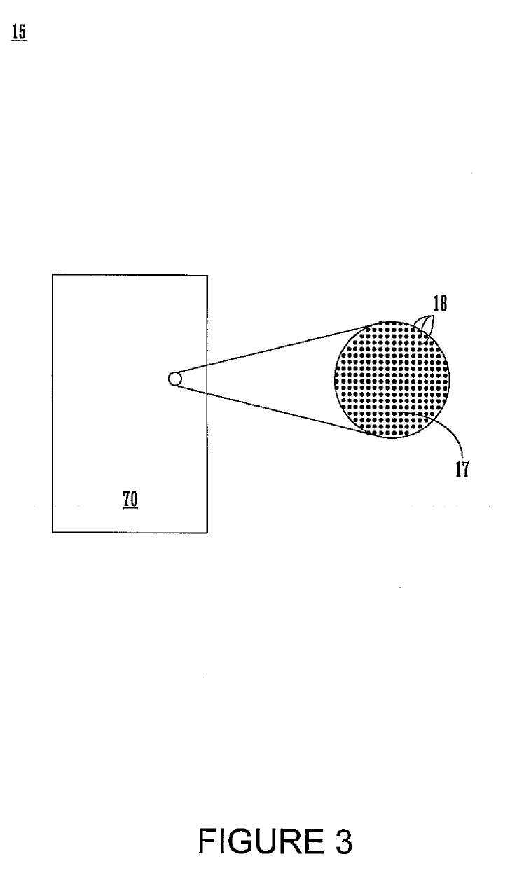

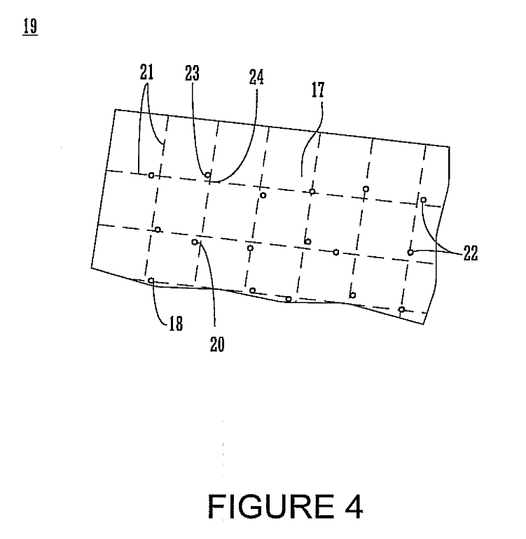

The surface 70 may be a sheet a paper, although the present invention is not so limited. In one embodiment, a pattern of markings is printed on surface 70. The end of pen device 100 that holds optical emitter 44 and optical detector 42 is placed against or near surface 70. As pen device 100 is moved relative to the surface 70, the pattern of markings are read and recorded by optical emitter 44 and optical detector 42. As discussed in more detail further below, in one embodiment, the markings on surface 70 are used to determine the position of pen device 100 relative to surface (see FIGS. 3 and 4). In another embodiment, the markings on surface 70 are used to encode information (see FIGS. 3 and 4). The captured images of surface 70 can be analyzed (processed) by pen device 100 to decode the markings and recover the encoded information.

Additional descriptions regarding surface markings for encoding information and the reading/recording of such markings by electronic devices can be found in the following patents and patent applications that are assigned to Anoto and that are all herein incorporated by reference in their entirety: U.S. Pat. No. 6,502,756, U.S. application Ser. No. 10/179,966, filed on Jun. 26, 2002, WO 01/95559, WO 01/71473, WO 01/75723, WO 01/26032, WO 01/75780, WO 01/01670, WO 01/75773, WO 01/71475, WO 10 00/73983, and WO 01116691.

Pen device 100 of FIG. 1 also includes a memory unit 48 coupled to the processor 32. In one embodiment, memory unit 48 is a removable memory unit embodied as a memory cartridge or a memory card. In another embodiment, memory unit 48 includes random access (volatile) memory (RAM) and read-only (non-volatile) memory (e.g., ROM, Flash, EEPROM, etc.) for storing information and instructions for processor 32.

In the embodiment of FIG. 1, pen device 100 includes a writing element 52 situated at the same end of pen device 100 as the optical detector 42 and the optical emitter 44. Writing element 52 can be, for example, a pen, pencil, marker or the like, and may or may not be retractable. In certain applications, writing element 52 is not needed. In other applications, a user can use writing element 52 to make marks (e.g., graphical elements) on surface 70, including characters such as letters, words, numbers, mathematical symbols and the like. These marks can be scanned (imaged) and interpreted by pen device 100 according to their position on the surface 70. The position of the user-produced marks can be determined using a pattern of marks that are printed on surface 70; refer to the discussion of FIGS. 3 and 4, below. In one embodiment, the user-produced markings can be interpreted by pen device 100 using optical character recognition (OCR) techniques that recognize handwritten characters.

As mentioned above, surface 70 may be any surface suitable on which to write, such as, for example, a sheet of paper, although surfaces consisting of materials other than paper may be used. Also, surface 70 may or may not be flat. For example, surface 70 may be embodied as the surface of a globe. Furthermore, surface 70 may be smaller or larger than a conventional (e.g., 8.5×11 inch) page of paper.

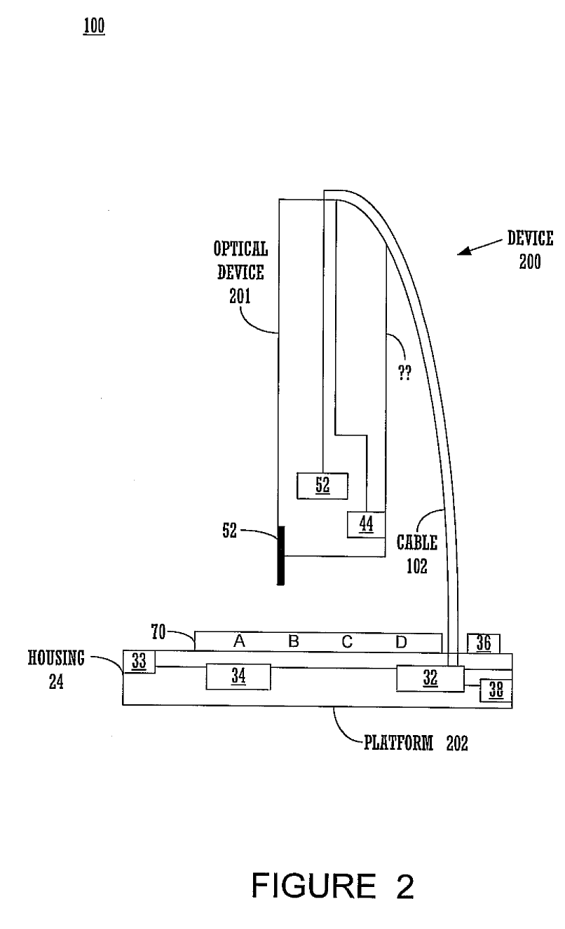

FIG. 2 is a block diagram of another device 200 upon which embodiments of the present invention can be implemented. Device 200 includes processor 32, power source 34, audio output device 36, input buttons 38, memory unit 48, optical detector 42, optical emitter 44 and writing element 52, previously described herein. However, in the embodiment of FIG. 2, optical detector 42, optical emitter 44 and writing element 52 are embodied as optical device 201 in housing 62, and processor 32, power source 34, audio output device 36, input buttons 38 and memory unit 48 are embodied as platform 202 in housing 74. In the present embodiment, optical device 201 is coupled to platform 202 by a cable 102; however, a wireless connection can be used instead. The elements illustrated by FIG. 2 can be distributed between optical device 201 and platform 200 in combinations other than those described above.

FIG. 3 shows a sheet of paper 15 provided with a pattern of marks according to one embodiment of the present invention. In the embodiment of FIG. 3, sheet of paper 15 is provided with a coding pattern in the form of optically readable position code 17 that consists of a pattern of marks 18. The marks 18 in FIG. 3 are greatly enlarged for the sake of clarity. In actuality, the marks 18 may not be easily discernible by the human visual system, and may appear as grayscale on sheet of paper 15. In one embodiment, the marks 18 are embodied as dots; however, the present invention is not so limited.

FIG. 4 shows an enlarged portion 19 of the position code 17 of FIG. 3. An optical device such as devices 100 and 200 (FIGS. 1 and 2) is positioned to record an image of a region of the position code 17. In one embodiment, the optical device fits the marks 18 to a reference system in the form of a raster with raster lines 21 that intersect at raster points 22. Each of the marks 18 is associated with a raster point 22. For example, mark 23 is associated with raster point 24. For the marks in an image/raster, the displacement of a mark from the raster point associated with the mark is determined. Using these displacements, the pattern in the image/raster is compared to patterns in the reference system. Each pattern in the reference system is associated with a particular location on the surface 70. Thus, by matching the pattern in the image/raster with a pattern in the reference system, the position of the pattern on the surface 70, and hence the position of the optical device relative to the surface 70, can be determined.

With reference back to FIG. 1, four positions or regions on surface 70 are indicated by the letters A, B, C and D (these characters are not printed on surface 70, but are used herein to indicate positions on surface 70). There may be many such regions on the surface 70. Associated with each region on surface 70 is a unique pattern of marks. The regions on surface 70 may overlap because even if some marks are shared between overlapping regions, the pattern of marks in a region is still unique to that region.

In the example of FIG. 1, using pen device 100 (specifically, using writing element 52), a user may create a character consisting, for example, of a circled letter “M” at position A on surface 70 (generally, the user may create the character at any position on surface 70). The user may create such a character in response to a prompt (e.g., an audible prompt) from pen device 100. When the user creates the character, pen device 100 records the pattern of markings that are uniquely present at the position where the character is created. The pen device 100 associates that pattern of markings with the character just created. When pen device 100 is subsequently positioned over the circled “M,” pen device 100 recognizes the pattern of marks associated therewith and recognizes the position as being associated with a circled “M.” In effect, pen device 100 recognizes the character using the pattern of markings at the position where the character is located, rather than by recognizing the character itself.

In one embodiment, the characters described above comprise “graphic elements” that are associated with one or more commands of the pen device 100. It should be noted that such graphic elements that are associated with, and are used to access the pen device 100 implemented functions comprising commands, are referred to as “graphic element icons” hereafter in order to distinguish from other written characters, marks, etc. that are not associated with accessing functions or applications of the pen device 100. In the example just described, a user can create (write) a graphic element icon that identifies a particular command, and can invoke that command repeatedly by simply positioning pen device 100 over the graphic element icon (e.g., the written character). In one embodiment, the writing instrument is positioned over the graphical character. In other words, the user does not have to write the character for a command each time the command is to be invoked by the pen device 100; instead, the user can write the graphic element icon for a command one time and invoke the command repeatedly using the same written graphic element icon.

Additionally, interacting with locations adjacent to graphic element icons can be used to perform a variety of functions or tasks. In one embodiment, tapping to the right of a graphic element icon can be used to select a function or menu item and tapping above or below the icon can be used to scroll or move up or down in a menu. Tapping to the left of the graphic element icon can be used to navigate to a previous menu. Similarly, tapping the center of the graphic element icon can be used to return to an application and reactivate the tapping areas. In one embodiment, the graphic element icons can include a letter or number with a line circumscribing the letter or number. The line circumscribing the letter or number may be a circle, oval, square, polygon, etc. Such graphic elements appear to be like “buttons” that can be selected by the user, instead of ordinary letters and numbers. By creating a graphic element icon of this kind, the user can visually distinguish graphic element icons such as functional icons from ordinary letters and numbers, which may be treated as data by the pen device 100. Also, by creating graphic element icons of this kind, the pen device may also be able to better distinguish functional or menu item type graphic elements from non-functional or non-menu item type graphic elements. For instance, a user may create a graphic element icon that is the letter “M” which is enclosed by a circle to create an interactive “menu” graphic element icon.

The pen device 100 may be programmed to recognize an overlapping circle or square with the letter “M” in it as a functional graphic element as distinguished from the letter “M” in a word. The graphic element icon may also include a small “check mark” symbol adjacent thereto. Computer code for recognizing such functional graphic elements and distinguishing them from other non-functional graphic elements can reside in the memory unit in the pen device. The processor can recognize the graphic element icons and can identify the locations of those graphic element icons so that the pen device 100 can perform various functions, operations, and the like associated therewith. In these embodiments, the memory unit may comprise computer code for correlating any graphic elements produced by the user with their locations on the surface.

It should be noted that the generic term “graphic element” may include any suitable marking created by the user, and is distinguishable from a graphic element icon which refers to a functional graphic element that is used to access one or more functions of the device.

As mentioned above, it should be noted that graphic element icons can be created by the pen device 100 (e.g., drawn by the user) or can be pre-existing (e.g., a printed element on a sheet of paper). Example graphic elements include, but are not limited to symbols, indicia such as letters and/or numbers, characters, words, shapes, lines, etc. They can be regular or irregular in shape. User written/created graphic elements are typically created using the pen device 100.

In one embodiment of the invention, the pattern of marks 17 of FIG. 3 is very large and covers many thousands square miles before repeating if printed in entirety. In one embodiment of the invention, a portion of the pattern of marks is divided into different regions that are associated with different sizes of writing surface. For example, a portion of the pattern of marks can be associated with a 3″×5″ writing surface and a different portion of the pattern of marks can be associated with an 8.5″×11″ writing surface. Furthermore, the different portions of the pattern of marks can be selected in sequence, such that a plurality of pages of a notebook comprise associated patterns of marks in sequence. This allows recognition of a particular page number based on the particular pattern of dots.

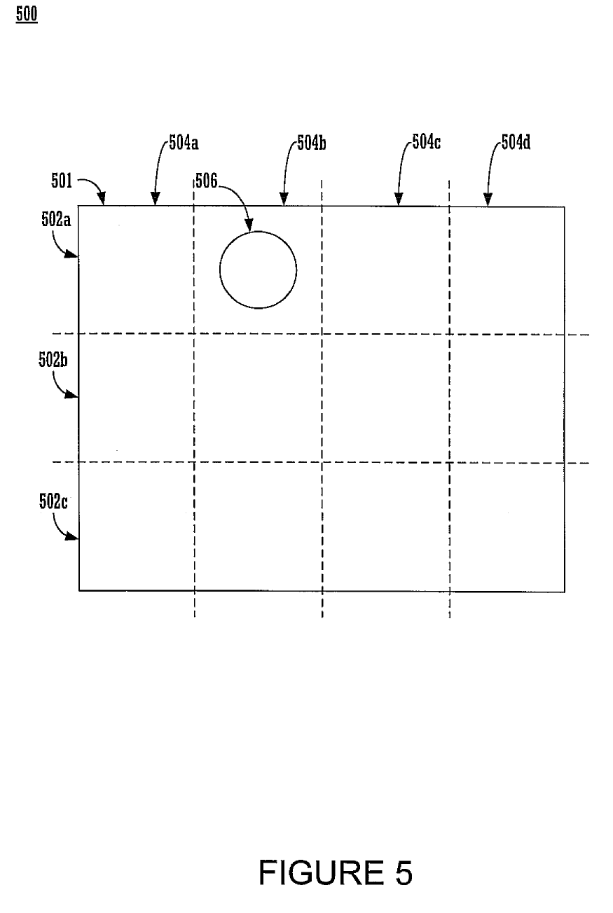

FIG. 5 shows an exemplary identifier selection in accordance with one embodiment of the present invention. Surface 501 may include encoded information (e.g., dot space) as described herein. Surface 501 may be divided up into rows 502 and columns 504 (e.g., 2×2 inch areas). Each column and row may be used to define an area usable for a unique identifier. For example, identifier 506 is based on the area bounded by row 502a and column 504b. The identifiers allow a device (e.g., pen device 100 or device 200) to differentiate the pages of a writing surface (e.g., notebook) with the same encoding from the pages of another writing surface (e.g., notebook).

In one exemplary embodiment, each of rows 502 corresponds to a color of a notebook having a different dot space and each of columns 504 corresponds to a unique notebook identification. Broadly speaking embodiments can utilize a set of unique identifiers to enable random access to a large number of different notebooks (e.g., periodically occurring dot space). It is appreciated that a set of unique identifiers may be derived from a variety of algorithms used to associate a dot space with the recurring dot space. It is further appreciated that identifiers (e.g., identifier 506) may be used identify a variety of surfaces including, but not limited to, notebooks, journals, binders, books, workbooks, and individual pieces of paper.

For example, a student may have two notebooks, one for math and one for science each notebook having the same dot space spread across their pages. Each notebook further has an identifier sticker on the cover which uniquely identifies the notebook. The student taps the identifier of a notebook with a pen device before writing into a notebook to ensure the writing is stored in the correct file. For example, prior to use of the math notebook the student taps an identifier sticker on the front of the math notebook. The identification stickers thus allow the student to use both notebooks without writing over the writing stored for other notebook. If the student does not tap the identification sticker prior to writing, the pen device may assume the same notebook is being used.

Such identification allows a user to write in one notebook having a particularly dot space, then write in another notebook (having the same dot space) and then come back to the first notebook with the writing being stored in separate files. Users are able to access a file corresponding to a notebook and update or add writing throughout the notebook and corresponding file. Thus, embodiments of the invention facilitate random access across an entire library of writing surfaces.

In one embodiment, identifiers (e.g., identifier 506) can be made into stickers. The sticker may then be applied to a writing surface (e.g., notebook) at manufacturing. A set of stickers could be distributed in a package for application by a user to a variety of writing surface (e.g., notebooks, journals, binders, etc). In one embodiment, identifiers have a number corresponding to the unique ID which may be printed in a human readable format on an identifier.

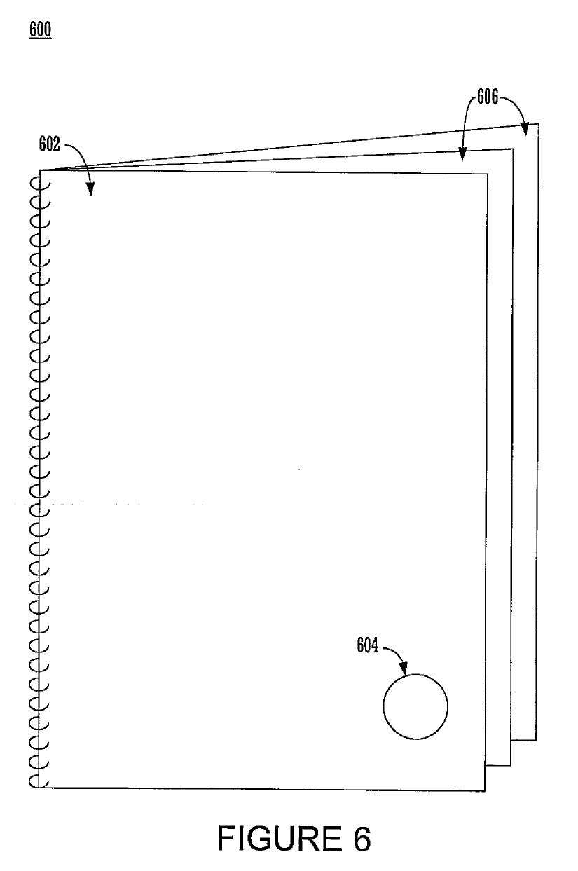

FIG. 6 shows an exemplary notebook in accordance with one embodiment of the present invention. Notebook 600 includes cover 602, identifier 604, and plurality of writing surfaces 606 (e.g., pages). In one embodiment, each page of the plurality of writing surfaces 606 in notebook 600 is a portion of a dot space different from the dot space of identifier 604. Identifier 604 may be placed on cover 602. It is appreciated that identifier 604 may be placed in numerous places easily accessible by a user (e.g., top of the first page, inside cover, or the like).

In the exemplary embodiment, the present invention is implemented as an interactive device (e.g., pen device 100 or device 200) and includes software which when executed by a processor is responsive to a user selection of an identifier (e.g., identifier 604). The identifier is used to identify or select a data file corresponding to a group of writing surfaces (e.g. writing surfaces 606). The software further stores or appends input information based on user actions (e.g., writing on the writing surfaces). For example, the input may be stored as a plurality of strokes (e.g., including x and y coordinates) during writing with a writing element of the interactive device.

In one exemplary embodiment, the software facilitates random access to the file corresponding to a notebook. As described herein, the software is responsive to an identifier that is a portion (e.g., row and column) of a dot space different from a dot space of the group of writing surfaces. For example, the software may be used to correctly store input from a user into file corresponding to English and Math notebooks having the same dot space.

In one embodiment, the software may append input to the last used notebook unless the user taps on a new notebook identification sticker. For example, if a user writes in a science notebook and later returns to using the science notebook, the software may append the additional writing to the file associated with the science notebook. The software may further be responsive to encountering an encoding (e.g., dot space) different from the last detected encoding. For example, if user has a history notebook with a particular encoding and an economics notebook with a different encoding, the software will add input as the user starts writing in the economics notebook (after the history notebook) as soon the encoded information from the economics notebook is detected (e.g., by an optical detector). It is appreciated that the software may add input to the file corresponding to the last writing surface with the same encoding (e.g., economics notebook was used just prior to the history notebook).

In one embodiment, the software can upload the identifier and information associated with the identifier (e.g., input from a user such as writing and the like) to a computer coupled with the interactive device. The identifiers (e.g., identifier 604) may further allow the interactive device to upload or send information to the correct notebook file. For example, an interactive device with the software may synchronize information such as writing was added to certain pages of two different notebooks. The software thus allows a user to go back to any page of a notebook that was previously written on and write more. Once the files on the interactive device have been uploaded to a computer, the files may easily be searched.

The software may support or facilitate a variety of features software on a computer. The software may support each notebook and identifier being associated with a particular user of the computer or interactive device. The software may also support each notebook being assigned a name (e.g., Science, Math, or like) which may be displayed on a display device of the interactive device.

In another embodiment, the software assumes a default file corresponding to a notebook. For example, if a user starts writing in a notebook, the input may be stored in a default file and upon the user tapping (e.g., with interactive device 100) an identifier a new file is created and used to store input (e.g., writing). The file may later be merged on a computer.

The present invention may also be implemented as an operating system of a computer system. The operating system can detect a unique identifier (e.g., identifier 604) corresponding to a writing surface (e.g., plurality of pages of notebook or pieces of papers). The operating system can then use the identifier to select a data file corresponding to the writing surface (e.g., a science notebook). The operating system can further store information (e.g., x and y coordinates related to writing strokes) based on actions performed on the writing surface. As described herein, the identifier may be on a coversheet and be a portion (e.g., a row and column) of an encoding (e.g. dot space) different from the encoding on the writing surface.

In one exemplary embodiment, the operating system can upload the identifier and information associated with the identifier (e.g. data file for a notebook) to a computer coupled with an interactive device running the operating system. The operating system can further facilitate appending and random access to the data file corresponding to the writing surface.

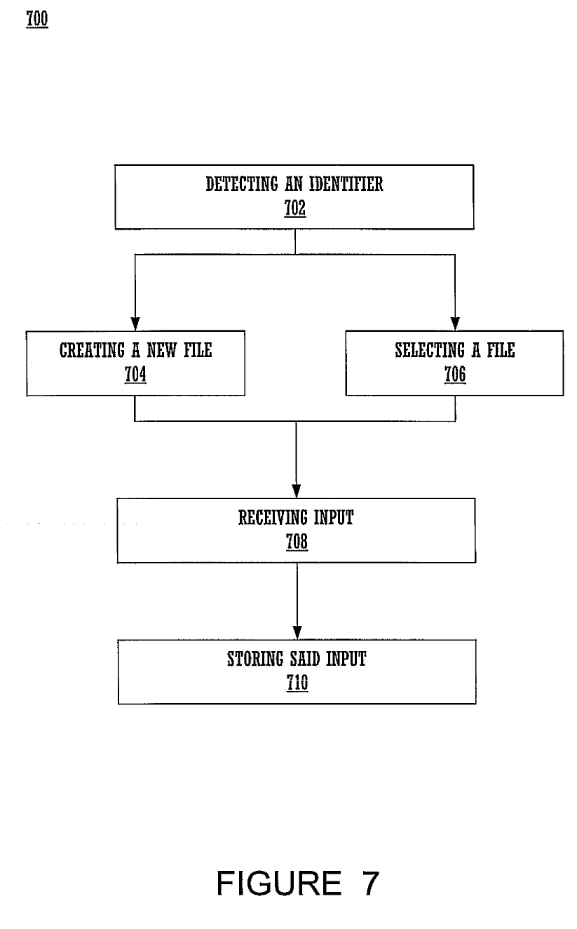

The following discussion sets forth in detail the operations of the present technology for network communication management. With reference to FIG. 7, flowchart 700 illustrates example blocks used by various embodiments of the present technology. Flowchart 700 includes processes that, in various embodiments, are carried out by a processor under the control of computer-readable and computer-executable instructions. Although, specific blocks are disclosed in flowchart 700, such blocks are examples. That is, embodiments are well suited to performing various other blocks or variations of the blocks recited in flowchart 700. It is appreciated that the blocks in flowchart 700 may be performed in an order different than presented, and that not all of the blocks in flowchart 700 may be performed.

FIG. 7 shows a flowchart of a process for facilitating data organization in accordance with one embodiment of the present invention. It is appreciated that the process of flowchart 700 may be performed by pen device 100 or device 200.

At block 702, an identifier corresponding to a writing surface is detected. The identifier may be detected upon a user tapping an interactive device on the identifier (e.g., on the cover of a notebook) via an optical detector. In one embodiment, the identifier is a portion (e.g., row and column) of an encoding (e.g., dot encoding) different from the encoding on an attached writing surface (e.g., pages of a notebook).

At block 704, a new file is created corresponding to the writing surface. In one embodiment, when an identifier is detected for the first time, a new file is created for storing actions (e.g., writing strokes) associated with the writing surface (e.g., notebook). For example, when a user purchases a notebook and the identifier is detected, a new file is created that will be used to store information based on the user writing in that notebook.

At block 704, a file corresponding to the writing surface is selected. The file selected may be a file that was previously used for storing data of a user's actions with respect to the writing surface. For example, the file could contain the first half of a students semester notes for a science class. As described herein, the file could also be a new file for a new writing surface that has now been identified.

At block 706, input via an optical detector is received when a writing element contacts the writing surface. In one embodiment, an interactive device with an optical detector detects the location of a writing element based the location depicted by encoding (e.g., dot encoding) on the writing surface. As the user moves the device a plurality of coordinates (e.g., x and y) and strokes may be calculated or determined.

At block 708, the input is stored in the file corresponding to the writing surface. In one embodiment, the strokes and coordinates are added to the appropriate location of the file. For example, a user's day of notes may be appended to a file corresponding to a science notebook. Similarly, when a user adds notes to previously written notes, the notes may be stored on the appropriate page and place in the file. Thus, embodiments of the present invention facilitate appending data and random access to files corresponding to writing surfaces.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. An interactive device comprising:
a bus;
a processor coupled to said bus;
a memory unit coupled to said bus;
a writing element for allowing a user to create written items on a surface;
an optical detector coupled to said bus for detecting information on said surface; and
wherein software executed by said processor is responsive to a user selection of an identifier corresponding to a group of writing surfaces, wherein said identifier is used to identify a data file corresponding to said group of writing surfaces and wherein said software stores information based on writing on said group of writing surfaces.

2. The interactive device of claim 1 wherein said identifier is a portion of a dot space different from a dot space of said group of writing surfaces.

3. The interactive device of claim 2 wherein said portion of dot space comprises a row and column of a dot space.

4. The interactive device of claim 1 wherein said software is operable to upload said identifier and information associated with said identifier to a computer coupled with said interactive device.

5. The interactive device of claim 1 wherein said software facilitates appending said data file corresponding to said group of writing surfaces.

6. The interactive device of claim 1 wherein said software facilitates random access to a file associated with a dot space.

7. The interactive device of claim 1 wherein said data file comprises a plurality of strokes made by said writing element.

8. The interactive device of claim 1 wherein said writing surface comprises a plurality of pages and said identifier is located on a cover sheet of said writing surface.

9. An operating system of a computer system, wherein said operating system is operable to detect a unique identifier corresponding to a writing surface, wherein said identifier is used to select a data file corresponding to said writing surface, and said operating system is further operable to store information based on actions performed on said writing surface in said data file corresponding to said writing surface.

10. The operating system of claim 9 wherein said identifier is a portion of a dot space different from a dot space of said writing surface.

11. The operating system of claim 10 wherein said portion of dot space comprises a row and column of a dot space.

12. The operating system of claim 9 said operating system is operable to upload said identifier and information associated with said identifier to a computer coupled with said interactive device.

13. The operating system of claim 9 wherein said operating system facilitates appending said data file corresponding to said writing surface.

14. The operating system of claim 9 wherein said software facilitates random access to a file associated with said writing surface.

15. The operating system of claim 9 wherein said data file comprises a plurality of strokes made by said writing element.

16. The operating system of claim 9 wherein said writing surface comprises a plurality of pages and said identifier is located on a cover sheet of said writing surface.

17. A method for facilitating data organization, said method comprising:
detecting an identifier corresponding to a writing surface;
selecting a file corresponding to said writing surface;
receiving input via an optical detector when a writing element contacts said writing surface; and
storing said input in said file corresponding to said writing surface.

18. The method as described in claim 17 further comprising:
creating a new file corresponding to said writing surface.

19. The method as described in claim 17 wherein said storing facilitates random access to said file corresponding to said writing surface.

20. The method as described in claim 17 wherein said input is appended to said file corresponding to said writing surface.
